(19) United States
(12) Patent Application Publication
(10) Pub. No.: US 2001/0050003 A1
(43) Pub. Date: Dec. 13, 2001

(54) Method and system for maintaining beverage temperature in a portable dispensing container

(76) Inventor: Timothy D. Gantt, Goshen, KY (US)

Correspondence Address: David W. Nagle, Jr., Stites & Harbison, PLLC, Suite 1800, 400 West Market Street, Louisville, KY, 40202-3352, US

(21) Appl. No.: 09/761,425

(22) Filed: Jan. 16, 2001

Related U.S. Application Data
(60) Provisional application No. 60/176,613, filed on Jan. 18, 2000.

(51) Int. Cl. A23L 1/00; A47J 31/00

(52) U.S. Cl. 99/275; 99/323.3

(57) ABSTRACT

A portable dispensing container includes an internal holding vessel for receiving and dispensing a hot beverage. The internal holding vessel is wrapped with a high-temperature plastic jacket which extends from the bottom surface of the holding vessel to its upper lip, the jacket further including an inlet port and an outlet port. Heated air is introduced into the jacket through the inlet port and circulates about the periphery of the holding vessel until exiting through the outlet port. The circulating air maintains the surfaces of the holding vessel at a desirable and constant temperature, a temperature that is substantially equivalent to the temperature of the heated beverage contained in the holding vessel.

### BACKGROUND OF THE INVENTION

This application claims priority from U.S. provisional application 60/176,613 filed Jan. 18, 2000 and relates to a portable dispensing container for coffee and similar hot beverages. The entire disclosure contained in U.S. provisional application 60/176,613 is incorporated herein by this reference.

In the food service industry, the prompt availability of high quality hot beverages, predominantly coffee, is a necessity. Since customers may request such beverages in sporadic intervals and in varying amounts throughout the day, it has become necessary to have large volumes of fresh beverage available on demand. At the same time, it is desirable to provide beverage dispensing capabilities at a number of locations throughout a restaurant or other location so that servers or other wait staff do not need to return to the brewer to retrieve a fresh beverage.

Thus, manufacturers of coffee brewers have developed “satellite” brewing systems. In such systems, the beverage is brewed at a central location, and then transported in separate and portable dispensing containers to various convenient locations at which the beverage can be dispensed for consumption. For a further discussion of satellite brewing systems, see, e.g., U.S. Pat. No. 5,907,993 issued to Van Camp, et al. and U.S. Pat. No. 4,621,571 issued to Roberts; each of these patents is incorporated herein by reference.

Satellite systems, however, do present some problems. Of preeminent concern is the difficulty in maintaining the beverage, which is commonly contained within a stainless steel or glass holding vessel within the portable dispensing container, at a proper temperature to ensure palatability of the beverage over an extended period of time. The beverage is often held in the dispensing container until all of the beverage has been dispensed, perhaps three or four hours.

Insulating the containers is one alternative, but common insulators can only maintain the beverage temperature for short periods of time. To maintain the beverage at a desired elevated temperature for longer periods of time, platforms have been designed which contain electric heating elements. A dispensing container is placed on such a platform, and heat generated by the electrical heating elements is transferred to the holding vessel through the bottom surface thereof by both conduction and convection.

Unfortunately, one effect of heating the beverage in this manner is that the surfaces of the holding vessel, and particularly the bottom surface, reach temperatures that are high enough to cause the beverage to change chemically over time, thus affecting the quality of the beverage and possibly rendering it unpalatable. Such degradation of the quality of the beverage is sufficiently problematic that many vendors will dispose of any beverage that is not consumed within an established time period following brewing, often in the range of twenty to forty minutes. Quite clearly, this results in a waste of product and adds to the vendor's operating costs.

It has been discovered that the degradation of the quality of the beverage is primarily a result of the high temperatures at the boundary between the holding vessel and the beverage. These high temperatures are a consequence of the method of heating described above, the direct heating of the vessel along its bottom surface by adjacent electric heating elements. Thus, when the beverage temperature is optimal, the temperatures along the surface of the holding vessel adjacent the heating elements may be two to three times as great as the desired beverage temperature. By contrast, if the surfaces of the holding vessel from top to bottom can be maintained at a constant temperature level, the temperature level that is optimal for the beverage itself, the rate of the chemical reactions that cause the beverage degradation is greatly diminished. Indeed, such chemical reactions may cease to occur.

Furthermore, if the area surrounding the holding vessel is maintained at a temperature substantially equivalent to the beverage temperature, heat loss is minimal.

It is therefore a paramount object of the present invention to provide a design and construction of a portable dispensing container for a satellite brewing system that provides for maintaining the beverage and the holding vessel at a constant and desired temperature, thus extending the time period that the beverage can be maintained in the dispensing container without significant degradation of the quality of the beverage.

This and other objects and advantages of the present invention will become apparent upon a reading of the following description.

### SUMMARY OF THE INVENTION

The present invention is a method and system for maintaining beverage temperature in a portable dispensing container. A preferred dispensing container in accordance with the present invention is formed from a substantially hollow housing and includes a front wall, a rear wall, and opposing side walls. The housing of the dispensing container further includes a bottom wall and a top wall, said top wall defining an opening for receiving a detachable lid. The beverage is received from a brewer through the opening defined by the top wall of the housing and is received into an internal holding vessel. The holding vessel is in liquid communication with a conventional nozzle mounted on a lower portion of the front wall of the dispensing container. Most importantly, the dispensing container is adapted for connection and integration with a unique heating system that maintains the beverage and the holding vessel at a constant and desired temperature. More specifically, the holding vessel is wrapped with a high-temperature plastic jacket which extends from the bottom surface of the holding vessel to its upper lip, the jacket further including an inlet port and an outlet port. Heated air is introduced into the jacket through the inlet port and circulates about the periphery of the holding vessel until exiting through the outlet port. The circulating air maintains the surfaces of the holding vessel at a desirable and constant temperature, a temperature that is substantially equivalent to the temperature of the heated beverage contained in the holding vessel.

### BRIEF DESCRIPTION OF THE DRAWINGS

FIG. 1 is a front perspective view of a preferred embodiment of a portable dispensing container made in accordance with the present invention;

FIG. 2 is a rear perspective view of the portable dispensing container of FIG. 1; and

FIG. 3 is a schematic representation of the portable dispensing container of FIG. 1 in combination with a heating and air circulation means.

### DESCRIPTION OF THE PREFERRED EMBODIMENTS

The present invention is a method and system for maintaining beverage temperature in a portable dispensing container 10. Aside from the heating system, which will be discussed in more detail below, this dispensing container 10 has a typical construction. As shown in FIGS. 1-3, the dispensing container 10 is formed from a substantially hollow housing 12, preferably fabricated from stainless steel, aluminum, or other metal material. This housing 12 includes a front wall 12a, a rear wall 12b, and opposing side walls 12c, 12d. The housing 12 of the dispensing container 10 further includes a bottom wall 12e and a top wall 12f, said top wall 12f defining an opening 13 for receiving a detachable lid 14.

The beverage is received from a brewer through the opening 13 defined by the top wall 12f of the housing and is received into an internal holding vessel 16, said holding vessel 16 being preferably constructed of stainless steel or glass. The holding vessel 16 is in liquid communication with a conventional nozzle 18 mounted on a lower portion of the front wall 12a of the dispensing container 10; opening of this nozzle 18 allows a user to dispense beverage. The dispensing container 10 also preferably includes a conventional sight glass 20 mounted on the front wall 12a thereof and in fluid communication with the holding vessel 16 to provide a visual indication of the volume of beverage remaining in the dispensing container 10.

Unlike prior art dispensing containers, however, the dispensing container 10 of the present invention is adapted for connection and integration with a unique heating system that maintains the beverage and the holding vessel 16 at a constant and desired temperature. More specifically, in the preferred embodiment shown in FIG. 3, the holding vessel 16 is wrapped with a high-temperature plastic jacket 22. One preferred material for constructing the jacket would be polycarbonate, although other plastic materials could be used as long as they have a minimum heat deflection temperature of approximately 250° F.

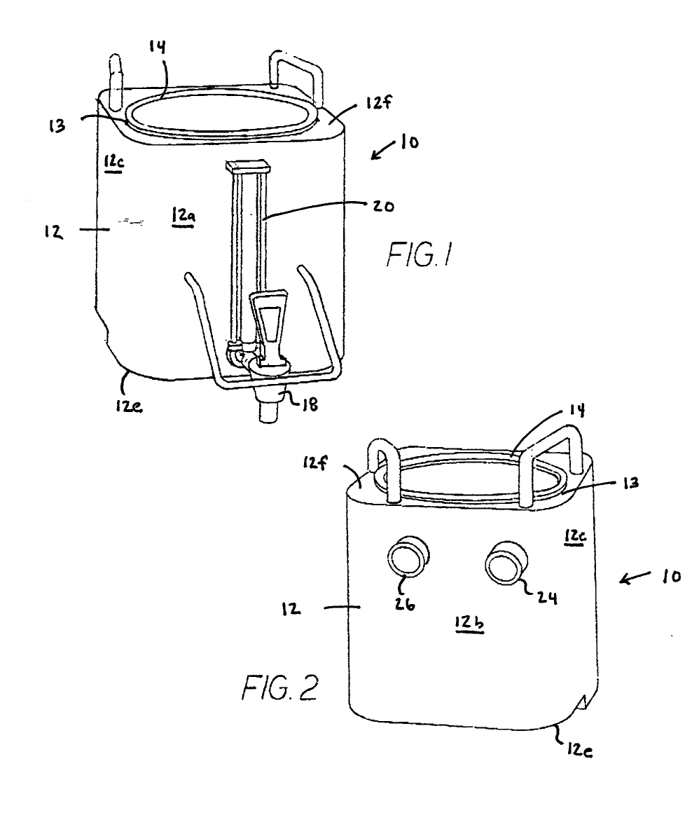

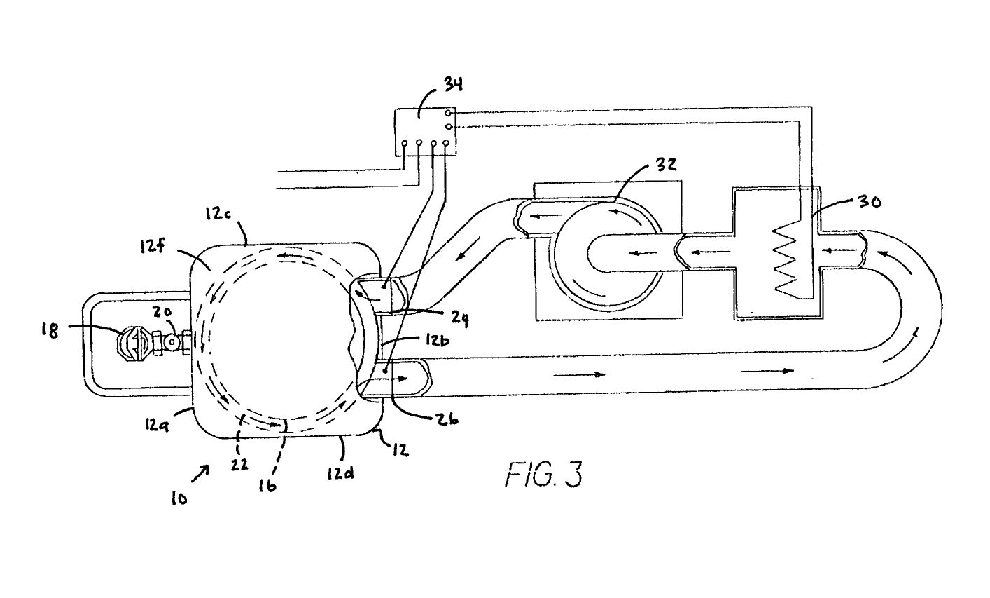

This high-temperature jacket 22 extends from the bottom surface of the holding vessel 16 to its upper lip. This jacket 22 has an inlet port 24 and an outlet port 26, each of said ports 24, 26 being accessible through the rear wall 12b of the dispensing container 10, as best shown in FIG. 2. Heated air is introduced into the jacket 22 through the inlet port 24 and circulates about the periphery of the holding vessel 16 until exiting through the outlet port 26. The circulating air maintains the surfaces of the holding vessel 16 at a desirable and constant temperature, a temperature that is substantially equivalent to the temperature of the heated beverage contained in the holding vessel 16. Thus, there is no perceptible temperature gradient between the beverage and the holding vessel 16, and between the holding vessel 16 and the circulating air. Consequently, there is no significant heat transfer between the beverage and the holding vessel 16, nor is there any significant heat transfer between the holding vessel 16 and the circulating air. Most importantly, by maintaining the beverage temperature in this manner, the surface temperatures of the holding vessel 16 are not high enough to be detrimental to beverage quality.

In the particular embodiment shown in FIGS. 1-3, heating and circulation of the air is accomplished through the use of a simple electrical resistance heating element 30 in series with a fan or blower 32, said heating element 30 and fan 32 being located external to the dispensing container 10 itself. Referring to FIG. 3, the temperature of this circulating air is controlled by a thermostat 34; as shown, this thermostat 34 receives signals indicating the temperature of the circulating air at the inlet and outlet ports 24, 26 of the jacket 22. If the temperature of the circulating air falls below a desired level, the heating element 30 is activated; if the temperature of the circulating air rises above the desired level, the heating element 30 is deactivated. Again, in the preferred embodiment shown, the heating element 30 and fan 32 are external to the dispensing container 10; however, the heating element 30 and fan 32 could also be contained within the housing 12 of the dispensing container without departing from the spirit and scope of the present invention.

As a further refinement, it is contemplated that when the portable dispensing container is stationed at a central brewer, the air circulating through the jacket could be heated by utilizing the stored heat energy of the water contained in the brewer through the use of a heat exchanger. Such a construction would eliminate the need for a separate heating element while the portable dispensing container is stationed at the central brewer.

It will also be obvious to those skilled in the art that other modifications may also be made to the preferred embodiment described herein without departing from the spirit and scope of the present invention.

1. A beverage dispensing container, comprising:
an external housing;
an internal holding vessel contained within said external housing and adapted to receive and retain a beverage to be dispensed;
a dispensing nozzle mounted to said external housing and in liquid communication with said internal holding vessel; and
a high-temperature jacket adjacent to and extending around said internal holding vessel, said jacket having an inlet port and an outlet port, and said jacket being adapted to receive and circulate heated air about said internal holding vessel with air being drawn through said inlet port, circulating about said internal holding vessel, and exiting through said outlet port such that said internal holding vessel is maintained at a substantially constant temperature.

2. A beverage dispensing container as recited in claim 1, wherein the heated air is circulated through said high-temperature jacket by an external fan and heated by an external heating element.

3. A beverage dispensing container as recited in claim 2, wherein said heating element is an electrical resistance heating element.

4. A beverage dispensing container as recited in claim 2, wherein said heating element is a heat exchanger.

5. A beverage dispensing container as recited in claim 4, wherein said heat exchanger is integral with a brewer, such that when the portable dispensing container is stationed at said brewer, the stored heat energy of the water contained in the brewer is used to heat the circulating air through the use of said heat exchanger.

6. A beverage dispenser as recited in claim 1, wherein said internal holding vessel is composed of glass.

7. A beverage dispenser as recited in claim 1, wherein said high-temperature jacket is composed of polycarbonate.

8. A beverage dispensing container, comprising:
an external housing;
an internal holding vessel contained within said external housing and adapted to receive and retain a beverage to be dispensed;
a dispensing nozzle mounted to said external housing and in liquid communication with said internal holding vessel;
a high-temperature jacket adjacent to and extending around said internal holding vessel, said jacket having an inlet port and an outlet port;
a means for circulating air through the high-temperature jacket with air being drawn through said inlet port, circulating about said internal holding vessel, and exiting through said outlet port; and
a means for heating the air circulated through the high-temperature jacket, the heated air maintaining said internal holding vessel at a substantially constant temperature.

9. A beverage dispensing container as recited in claim 8, wherein said means for heating the air is an electrical resistance heating element.

10. A beverage dispensing container as recited in claim 8, wherein said means for heating the air is a heat exchanger.

11. A beverage dispensing container as recited in claim 9, wherein said means for circulating air is a fan which is in series with said electrical resistance heating element.

12. A beverage dispensing container as recited in claim 10, wherein said means for circulating air is a fan which is in series with said heat exchanger.

13. A beverage dispensing container as recited in claim 10, wherein said heat exchanger is integral with a brewer, such that when the portable dispensing container is stationed at said brewer, the stored heat energy of the water contained in the brewer is used to heat the circulating air through the use of said heat exchanger.

14. A beverage dispenser as recited in claim 8, wherein said internal holding vessel is composed of glass.

15. A beverage dispenser as recited in claim 8, wherein said high-temperature jacket is composed of polycarbonate.

16. A method for maintaining beverage temperature in a portable dispensing container including an internal holding vessel adapted to receive and retain a beverage to be dispensed, comprising the steps of:
providing a high-temperature jacket adjacent to and extending around said internal holding vessel, said jacket having an inlet port and an outlet port;
circulating air through said high-temperature jacket with air being drawn through said inlet port, circulating about said internal holding vessel, and exiting through said outlet port; and
heating the air circulated through the high-temperature jacket, the heated air maintaining said internal holding vessel at a substantially constant temperature.
